(19) United States
(12) Patent Application Publication
(10) Pub. No.: US 2007/0298179 A1
(43) Pub. Date: Dec. 27, 2007

(54) Coating System for Surface Lacquering, Forming a Crackled Lacquer and Method for the Production of Said Coating System

(75) Inventor: Roger Konig, Dessau (DE)

Correspondence Address: NORRIS, MCLAUGHLIN & MARCUS, P.A., 875 THIRD AVE, 18TH FLOOR, NEW YORK, NY, 10022, US

(73) Assignee: KOENIG LACKIERFACHBETRIEB GMBH, Dessau (DE)

(21) Appl. No.: 10/596,618

(22) PCT Filed: Dec. 17, 2004
(86) PCT No.: PCT/EP04/14749

§ 371 Date: May 21, 2007

(30) Foreign Application Priority Data
Dec. 16, 2004 (DE) 10 2004 061 172.6
Dec. 18, 2003 (DE) 103 59 861.8
Jan. 21, 2004 (DE) 10 2004 003 252.1

(51) Int. Cl. B05D 5/00

(52) U.S. Cl. 427/372.2

(57) ABSTRACT

The problem of the invention, which is to develop a method for the processing of a cracked lacquer structure and a coating system having in a leather-like surface, is solved by the fact that a coating system is deposited in one layer on an object surface as a base lacquer application with an arbitrary binder, then a water-soluble glaze application as an activator is immediately deposited in the spraying process onto this deposited coating system in the wet state and the surface of the second coating comprising a glaze application is then subjected to a briefly acting thermal shock or an air flow in order to initiate the hardening of the coating system.

The invention relates to a coating system for a colour- and effect-giving surface lacquering, which forms a cracked lacquer structure and then has a leather-like surface, and a method for the processing of coating systems with the same and/or different solvents.

Water-soluble surface coating agents are already known, the surface whereof has a cracked lacquer structure after hardening. A coating system is known according DE 296 13 266 U1, wherein a prime coat is applied on the surface of the object to be coated and a top coat is applied thereon after initial drying but before complete drying or hardening of the prime coat. The prime coat comprises a more elastic coating system than the top coat. The more inelastic top coat hardens richer in stresses than the prime coat. The more rapidly hardening top coat begins to crack on account of the lack of elasticity and forms a cracked lacquer structure at the surface.

The hardening properties of the employed coating systems for the prime coat and the top coat are determined by the employed initial materials. According to this known solution, the resin mixture of the prime coat dries and hardens preferentially in an oxidative manner slowly and inelastically, whereas the resin mixture of the top coat dries and hardens chemically reactively in a non-self-crosslinking or a self-crosslinking manner. A stress builds up in the forming top coat during the drying and hardening, said stress then leading to the crack formation on account of the stress difference with respect to the prime coat. There follows the formation of islands in the top coat, which “float” on the prime coat, so that the desired cracked lacquer structure is formed.

According to this solution, an alkyd resin hardening under oxygen oxygenation is preferably used as a binder resin for the prime coat. Mixed binder systems such as alkyd resin/acrylate resin mixtures are also mentioned as being able to be used in this solution. The crack formation can easily be influenced in a predetermined manner by the use of suitable binder systems on a water base for the prime coat, whereby the crack formation can be determined in particular by the employed types of alkyd resin on the one hand and by the employed quantity ratios of alkyd resin to acrylate resin or other polymer combinations in the dispersion mixture.

The two-layer coating can optionally be lacquered over after hardening of the systems and completion of the crack formation, i.e. the creation of the cracked lacquer structure.

The solution that has become known has the drawback that a continuously proceeding coating of a surface of an object to be coated cannot be carried out in a single working cycle. According to this solution, the applied prime coat cannot be covered with a top coat until the prime coat has already started to dry, but is not completely dried. Between the application of the prime coat and that of the top coat, exhaust air times of several minutes have to be observed with air assistance, in order that the more elastic prime coat, whose a binder hardens slowly and elastically largely in an oxidative manner, has already started to dry, but has not yet hardened, before the application of the top coat which hardens in a more stress-rich manner.

Dwell times of the object to be coated provided with a prime coat thus result, whereby it must be ensured that the temperature and the relative moisture content of the exhaust air are observed and the dwell time is limited in duration depending on the established system for the prime coat. As a result, industrialisation of the coating process is made much more difficult. The initial drying time is necessary with this two-layer system in order that the top coat does not react significantly with the prime coat.

A method of producing a leather imitation surface, i.e. a cracked lacquer surface, is known according to DE 102 22 116 A1. According to this method, a plurality of application coats are deposited one after the other on an object to be coated. The priming coat deposited on the surface must undergo a drying process before application of an intermediate coat. The drying of the priming coat, depending on the heat action, takes at least 20 minutes or, under room temperature conditions, up to an hour. The priming coat, which comprises a coloured commercially available priming lacquer, can be provided with an intermediate coat of a plasticised cellulose/synthetic resin combination at the earliest after a drying time of 20 minutes. According to the solution, the priming coat and the intermediate coat are adjusted with respect to one another in such a way that the priming coat is more elastic and softer than the intermediate coat. The coats deposited one after the other dry at room temperature. The intermediate coat cracks as a result of the differing shrinkage during the drying of the priming coat and the intermediate coat and a cracked lacquer structure with a scarred, leather-like structure arises. According to this solution, the intermediate coat is provided with a top coat of PUR lacquer, which has to undergo a drying process.

This solution is bound up with the same shortcoming as the teaching accorded to DE 296 13 266 U1. The more inelastic top coat can only be deposited on the prime coat after a certain reaction time, as a result whereof coating can only take place in successive working cycles.

The aim of the invention consists in using the processing of a coating system for a surface lacquering, which has a cracked lacquer structure, effectively in the assembly-line production of objects to be coated.

The problem underlying invention is to develop a method for the processing of a coating system, based on the same and/or different solvents and having a cracked lacquer structure and a leather-like surface, for a surface lacquering and a coating system that can be used for the latter.

The problem is solved with the technical teaching disclosed in the independent claims, with the inclusion of the technical teaching disclosed in the dependent claims. Proceeding from the known fact that a cracked lacquer structure is formed when two coats of lacquer with different elasticity deposited one upon the other can be hardened separately, whereby the base coat hardens more slowly and therefore more elastically than the top coat, a stratified elasticity is produced according to the invention by the fact that, with a wet-in-wet coating on a first lacquer application hardening more elastically, there takes place with an arbitrary solvent a second coating with an application system hardening more inelastically, comprising a low-viscosity commercially available glaze based on a water-soluble binder for wood sealing as an activator for the initiating reaction, with brief heating of the second coating comprising a glaze application or the subjecting thereof to an air flow, whereby the boundary layer between the base coat and the second application system is destroyed by the second coating system comprising a glaze deposited in the spraying process and, on account of the known molecular motion in the emerging mixing zone, the base coat is influenced by the solvent-containing addition of a high-boiler contained in minor quantities in the water-soluble glaze application, such as the high-boiler of the strongly hydroscopic butyl glycol or a similarly acting addition, and a delay in the hardening of the base coat is thus produced with a simultaneous acceleration of the hardening of the top coat.

According to the invention, the disclosed solution takes advantage of the fact that, with a wet-in-wet coating with two water-soluble coating systems or with two applications based on different solvents, although no influence is brought to bear between the solvents of the systems, a mixing zone arises with the destruction of the boundary layer of the base coat, which extends both into the base lacquer application as well as into the top coat. A more stratified elasticity it is thus always formed in the base lacquer application in the case of a wet-in-wet coating with a second coating with a water-soluble application system on a first lacquer application based on an arbitrary solvent. According to the invention, a two-layer stress distribution is thus brought about in the base coat and the top coat. The desired cracked lacquer structure then arises due to the influence of the kinematic viscosity of the base coat.

An alternative to this method consists, according to the invention, in the fact that all the constituents for use as the base lacquer application and as the glaze application are mixed shortly before the processing, i.e. before the coating of the object surface, and this mixture is then immediately deposited onto the object surface and subjected to the same heat treatment in a hot air flow for a brief period at a flow temperature of not less than approx 90° C. A cracked lacquer structure at the coated surface also arises as a result. The latter, however, has a cracked lacquer structure that is formed less precisely.

The invention will be explained in greater detail with an example of embodiment.

A water-soluble or a solvent-containing lacquer system is deposited onto a surface of the object to be coated using known technical means, whereby use is made, for example, of a water-soluble PUR lacquer system consisting of a component with a binder of aliphatic polyurethane in dispersion and an added acrylate copolymer combination or two components with a pH value in the almost neutral range between 7.8 to 8.0.

On this lacquer application, there then immediately takes place a second water-soluble coating application, comprising a commercially available glaze for wood sealing consisting of a combination of a low-viscosity binder dispersion of aliphatic polyurethane and an acrylate copolymer with an addition of a small quantity of an organic solvent of butyl glycol (C₄H₁₀O₂) known as a softener. The glaze application can comprise a pigment mixture in aqueous dispersion with a pH value of approx. 9.3, i.e. the glaze application reacts in a weakly alkaline manner. This coating application of a commercially available glaze contains a small organic solvent fraction of approx 3%, a water fraction of approx. 88.50% and a solid fraction of approx. 7.5 to 8.5%. After the application of the second coating agent in the spraying process, there is formed in the first lacquer application a mixing zone in which a molecular motion arises, which also extends into the boundary region of the second coating consisting of a glaze or PUR lacquer application, whereby this mixing zone has a film-like dimension. The hardening thereof is started by a brief period of heating of the second coating or exposure thereof to an air flow. This boundary layer reacts differently with respect to the base lacquer application and the cracked lacquer structure is formed.

As a binder for the base coat, use can optionally be made of derivatives of natural oils, reaction products both from unsaturated and saturated acids and alcohols, synthetic resins as derivatives of phenols, urea, melamine, acrylic acid, styrene, of ketones or of aldehydes, of amines, of silicon and of terpene hydrocarbons, polyvinyl compounds, organometallic compounds, polyurethane and polycarbamides, epoxy resins, nitrocellulose and cellulose compounds, rubber and their derivatives.

After the formation of the cracked lacquer structure in the surface of the coating after the surface coating of an object to be coated, other effect-producing lacquerings can be undertaken. Thus, for example, an application can take place with a soft feeling lacquer, which is understood to mean a lacquer which is such that it is characterised by a particular hapticity, i.e. touch quality. The soft-feel effect is essentially based on a combination of a braking and sliding effect and chiefly comprises a binder on a polyester/polyurethane base. As a result of the lacquering-on of a soft lacquer, the coated surface is endowed such that it gives the impression to the person who takes hold of or touches it that he is touching a leather-like object. Furthermore, the soft lacquer can also be mixed, or impregnated, with a liquid substance secreting an odorous substance. With a targeted selection of the odorous substance, it is possible, along with a soft lacquer application on the inventive coating with a cracked lacquer structure having a leather-like effect, for said coating also to take on a leathery odour. The effect-giving lacquer coating can be carried out on a coloured object to be coated or on such object with a coloured surface. Insofar as the coating is to be coloured, there is the possibility of colouring the colourless materials so as to match the colour of the object to be coated.

With the method according to the invention, a coating of a surface is obtained in a wet-in-wet process, i.e. without having to implement a necessary interruption for the purpose of initial drying of the first coating before a coating with a second application. As a result, this method according to the invention is more cost-effective than other known solutions for achieving a cracked lacquer structure.

Another advantage of the solution according to the invention consists in the fact that the coating with a cracked lacquer structure is insensitive with respect to a minor deformation of the coating caused by a pressure loading, i.e. this deformation is reversible. This deformation can be removed again by gentle heating of the coating with this deformation.

1-25. (canceled)

26. A method for forming a cracked lacquer on a surface, said method comprising:
a) applying first a liquid composition comprising a lacquer and abinder to the surface;
b) applying a second composition comprising an activator onto the first coat while the first coat is still in a liquid state;
c) exposing the second composition to heat or air flow to initiate hardening.

27. The method of claim 26, wherein the activator is a glaze.

28. The method of claim 26, wherein the activator is a water-soluble acrylate.

29. The method of claim 26, wherein the lacquer is water-soluble.

30. The method of claim 26, wherein the lacquer is a solvent.

31. The method of claim 26, wherein the second composition is heated to a temperature above 90° C. over in about 5 seconds.

32. The method of claim 26, wherein the second composition is exposed to an air flow of at least 0.4 bar.

33. The method of claim 26, wherein the binder is selected from the group consisting of derivatives of natural oils; reaction products of unsaturated acids and alcohols; reaction products of saturated acids and alcohols, synthetic resins of phenols, urea, melamine, acrylic acid, styrene, ketones, aldehydes, amines, silicon and terpealhydrocarbos; polyvinyl compounds; organometalic compounds; polymethane and polycarbamides; epoxy resins; nitrocallulox and cellulose compounds; and rubber and rubber derivatives; and mixtures thereof.

34. The method of claim 26, wherein the surface is further treated with a soft lacquer.

35. The method of claim 34, wherein the soft lacquer contains a fragrance.

36. The method of claim 26, wherein the first composition has a pH in the range of about 7.8 to 8.0.
